(19) United States
(12) Patent Application Publication
(10) Pub. No.: US 2017/0277428 A1
(43) Pub. Date: Sep. 28, 2017

(54) INFORMATION PROCESSING DEVICE, INFORMATION PROCESSING METHOD, AND NON-TRANSITORY COMPUTER READABLE MEMORY MEDIUM

(71) Applicant: CASIO COMPUTER CO., LTD., Tokyo (JP)

(72) Inventors: Yoichi MURAYAMA, Tokyo (JP); Toshihiko YOSHIDA, Tokyo (JP); Gou KAWAKAMI, Tokyo (JP); Kazuma KAWAHARA, Tokyo (JP); Takashi KAWASHIMO, Tokyo (JP); Hiroaki SHIMODA, Tokyo (JP)

(73) Assignee: CASIO COMPUTER CO., LTD., Tokyo (JP)

(21) Appl. No.: 15/376,784

(22) Filed: Dec. 13, 2016

(30) Foreign Application Priority Data
Mar. 24, 2016 (JP) 2016-059878

(51) Int. Cl. G06F 3/0488; G06F 3/0354

(52) U.S. Cl. CPC G06F 3/04886; G06F 3/03547; G06F 3/0488

(57) ABSTRACT

An information processing device according to the present disclosure includes a shape detector detecting a shape of a detection object, an output controller performing a control to select a virtual input device to be displayed based on the detected shape of the detection object, and to display the selected virtual input device, and a display displaying the selected virtual input device based on the control given by the output controller.

### CROSS-REFERENCE TO RELATED APPLICATION

This application claims the benefit of Japanese Patent Application No. 2016-059878, filed on Mar. 24, 2016, the entire disclosure of which is incorporated by reference herein.

### FIELD

This application relates generally to an information processing device, an information processing method, and a non-transitory computer readable memory medium.

### BACKGROUND

Technical developments of virtual keyboards which execute an inputting process by detecting a motion of a finger depressing a displayed keyboard are now in advancement.

For example, Unexamined Japanese Patent Application Kokai Publication No. 2014-165660 discloses a technology of specifying input information by a user via a virtual keyboard by extracting the skeleton information on a user's hand, and by tracking the motion of a fingertip and that of a joint.

There are various input devices, such as general QWERTY type keyboards, ten keys, and touchpads. Users selectively utilize the highly convenient input device in accordance with a utilization purpose. However, Unexamined Japanese Patent Application Kokai Publication No. 2014-165660 does not disclose a technology of automatically selecting one of multiple types of virtual input devices and of providing the selected input device.

The present disclosure has been made in view of the foregoing circumstances, and an objective is to provide an information processing device, an information processing method, and a non-transitory computer readable memory medium which are capable of providing a highly convenient virtual input device.

### SUMMARY

In order to accomplish the above objective, an information processing device according to an aspect of the present disclosure includes: a shape detector that detects a shape of a detection object; an output controller that performs a control to select a virtual input device to be displayed based on the detected shape of the detection object, and to display the selected virtual input device; and a display that displays the selected virtual input device based on the control by the output controller.

### BRIEF DESCRIPTION OF THE DRAWINGS

A more complete understanding of this application can be obtained when the following detailed description is considered in conjunction with the following drawings, in which:

FIG. 1 is a diagram illustrating a physical structure of an information processing device according to a first embodiment;

FIG. 2 is a diagram for explaining a displayed image of a virtual keyboard;

FIG. 3 is a diagram for explaining a relationship between the detected number of fingers and a virtual input device to be displayed;

FIG. 4 is a diagram illustrating a functional structure of the information processing device according to the first embodiment;

FIG. 5A is a diagram for explaining a case in which the detected number of fingers is 10;

FIG. 5B is a diagram for explaining a case in which the virtual input device to be displayed is a keyboard;

FIG. 6A is a diagram for explaining a case in which the detected number of fingers is five;

FIG. 6B is a diagram for explaining a case in which the virtual input device to be displayed is ten keys;

FIG. 7A is a diagram for explaining a case in which the detected number of fingers is one;

FIG. 7B is a diagram for explaining a case in which the virtual input device to be displayed is a touchpad;

FIG. 8 is a flowchart for explaining an information obtaining process executed by the information processing device according to the first embodiment;

FIG. 9 is a diagram for explaining a relationship between the detected number of fingers and a virtual input device to be displayed according to a first modified example;

FIG. 10 is a flowchart for explaining an information obtaining process executed by an information processing device according to the first modified example; and

FIG. 11 is a diagram for explaining an input key specifying method by an information processing device according to a second modified example.

### DETAILED DESCRIPTION

An information processing device, an information processing method, and a non-transitory computer readable memory medium according to an embodiment of the present disclosure will be explained below with reference to the accompanying drawings. The same or equivalent component will be denoted by the same reference numeral throughout the figures.

### First Embodiment

In this embodiment, an explanation will be given of an example case in which an information processing device 100 obtains information input via a virtual input device, and transmits the obtained information to a personal computer 200, and the personal computer 200 displays the obtained information. The information processing device 100 automatically changes the virtual input device to be displayed in accordance with the number of fingers when the user inputs the information. When, for example, the user inputs characters, a convenient input device for the user is a keyboard. In this case, the user places both hands with 10 spread fingers in an imaging area of an pickup device 110. Conversely, when a numerical calculation is executed, a convenient input device for the user is ten keys. In this case, the user places the one hand with five spread fingers in the imaging area of the pickup device 110. Depending on the utilization purpose, the user desires to utilize a touchpad. In this case, the user places the one hand with an spread index finger alone in the imaging area of the pickup device 110. The information processing device 100 detects the number of fingers spread and presented by the user, thereby providing a suitable virtual input device for the utilization purpose of the user corresponding to the detected number of fingers.

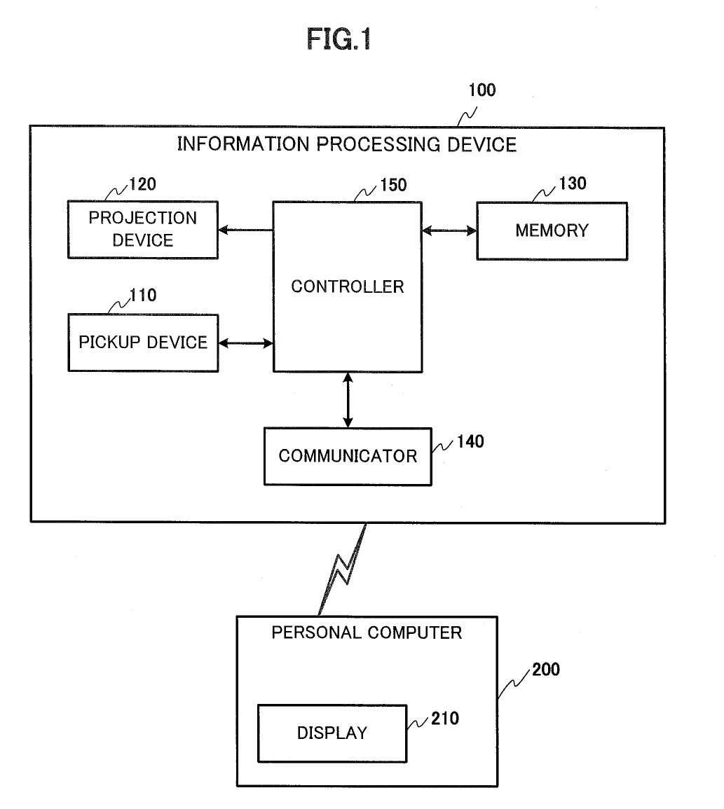

The information processing device 100 according to the first embodiment includes physical structures that are the pickup device 110, an projection device 120, a memory 130, a communicator 140, and a controller 150 as illustrated in FIG. 1.

The pickup device 110 picks up an image of a specific area adjacent to the information processing device 100 in order to pick up the user's hand (detection object) that utilizes the virtual input device. The pickup device 110 includes an imaging element like a Complementary Metal-Oxide Semiconductor (CMOS) sensor.

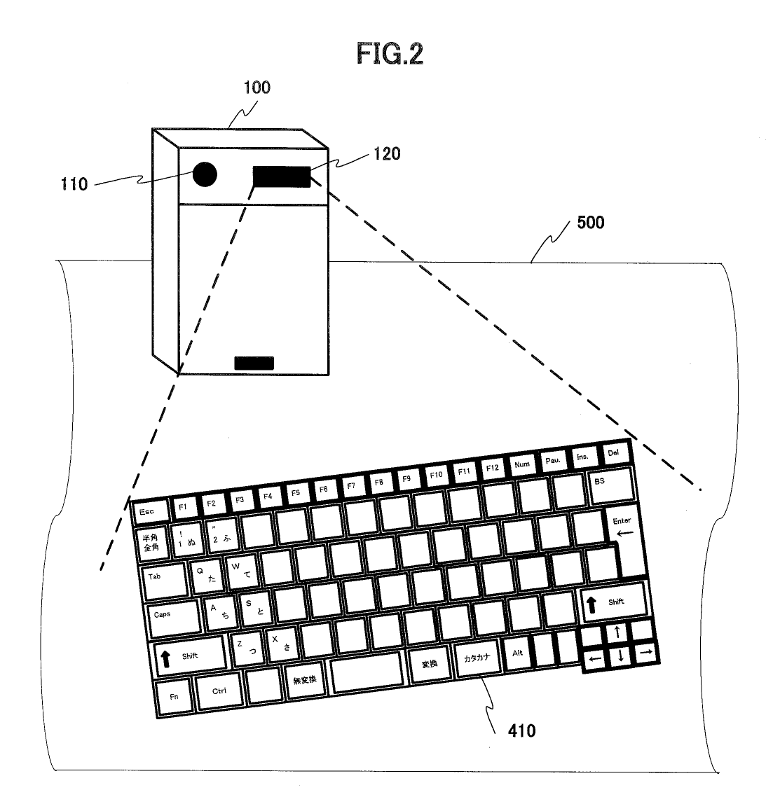

The projection device 120 projects the projection image of the virtual input device on a plane like a desk under the control by the controller 150. FIG. 2 is a diagram illustrating a case in which the projection device 120 that is under the control by the controller 150 projects a projection image 410 (input screen) of the specified virtual keyboard on a desk 500. The projection device 120 includes a red semiconductor laser, a holographic optical element, and the like. When there is a desire to change the color of the image to be projected to white or green, the color of the semiconductor laser may be changed.

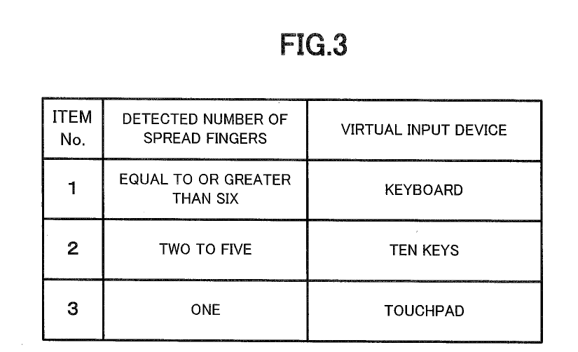

As illustrated in FIG. 3, the memory 130 illustrated in FIG. 1 stores the virtual input device associated with the number of user's spread fingers extracted from the image of the user's hand picked up by the pickup device 110. In addition, the memory 130 stores the information on the projection image of the virtual input device.

The communicator 140 has a function of transmitting the input information by the user via the virtual input device to the other device that is the personal computer 200. The communicator 140 may include a wireless communication module compatible with, for example, wireless Local Area Network (LAN), BLUETOOTH (registered trademark), ZigBee, Radio Frequency IDentifier (RF-ID), and Ultra Wide Band (UWB, ultra-wide-band wireless communication), or may include a wired communication module like Universal Serial Bus (USB) or Recommended Standard-232C (RS-232C).

The controller 150 executes an application program for the virtual input device, thereby displaying the projection image of the virtual input device, and obtaining the input information by the user. The details will be explained later. The controller 150 includes unillustrated Read Only Memory (ROM), Random Access Memory (RAM), Central Processing Unit (CPU), and the like. The ROM stores the application program for the virtual input device. The RAM functions as a work area for the CPU. The CPU executes the application program for the virtual input device, thereby accomplishing the functions to be explained later.

The personal computer 200 obtains, from the information processing device 100, the input information by the user via the virtual input device, and displays the obtained information on a display 210.

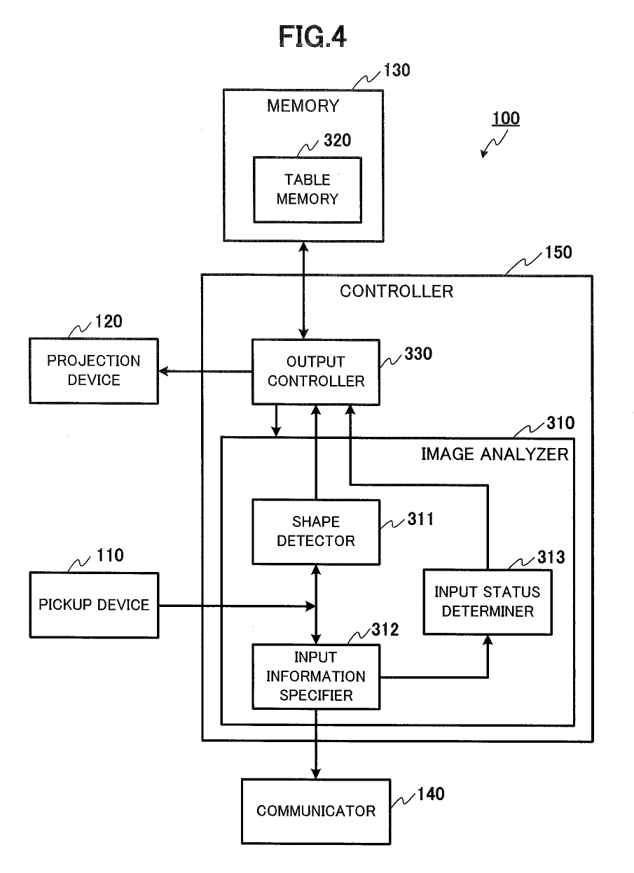

Next, an explanation will be given of a functional structure of the controller 150 with reference to FIG. 4. As illustrated in FIG. 4, the controller 150 includes functional structures that are an image analyzer 310, and an output controller 330. In addition, the image analyzer 310 includes functional structures that are a shape detector 311, an input information specifier 312, and an input status determiner 313. Still further, a table memory 320 is provided in the memory area of the memory 130.

The image analyzer 310 includes the shape detector 311 that detects the number of user's spread finger. In addition, the image analyzer 310 includes the input information specifier 312 that specifies the input information by the user via the virtual input device. Still further, the image analyzer 310 includes the input status determiner 313 that adjusts a timing at which the virtual input device to be provided to the user is changed.

The shape detector 311 analyzes the picked-up image by the pickup device 110, and specifies the number of user's spread fingers (the shape of the detection object). As for the detection method of the number of spread fingers, for example, the number of spread fingers is detectable by extracting the skeleton information on the hand from the picked-up image of the user's hand. When, for example, the hand is in an “paper” state with the five spread fingers, the number of spread fingers to be detected is five. When the hand is in an “scissors” state with two spread fingers, the number of spread fingers to be detected is two.

The input information specifier 312 specifies the information to be input by the user based on the motion of the user's finger on the input screen of the virtual input device. In this embodiment, which key is operated in the virtual input device by the user is specified by extracting the skeleton information on the hand from the picked-up image of the user's hand and by tracking the motion of a fingertip and that of a joint. In addition, the input information specifier 312 utilizes an image analysis program associated with the selected virtual input device by the output controller 330 to be explained later, thereby specifying the input information based on the motion of the user's finger. For example, the technology disclosed in Unexamined Japanese Patent Application Kokai Publication No. 2014-165660 is applicable as such a technology of specifying input information.

In order to control the timing at which the virtual input device to be provided to the user is changed, the input status determiner 313 monitors the processing status by the input information specifier 312. Next, when the user is inputting information via the virtual input device, in order to allow the user to keep utilizing this virtual input device, the input status determiner 313 notifies the output controller 330 of the inputting status by the user.

The table memory 320 stores a table that associates the number of user's spread fingers detected by the shape detector 311 with the virtual input device to be displayed. For example, an association table illustrated in FIG. 3 is stored. In this case, an explanation will be given of an example case in which three types of virtual input devices are applied which are a QWERTY type keyboard applied for a general personal computer, ten keys for an electronic desk calculator, and a touchpad applied instead of a mouse.

The output controller 330 selects, based on the table stored in the table memory 320, the virtual input device associated with the number of user's spread fingers detected by the shape detector 311. Next, the output controller 330 obtains the information on this virtual input device from the memory 130, and controls the projection device 120 so as to display the projection image of the virtual input device. In addition, when obtaining the information indicating the user being inputting from the input status determiner 313, the output controller 330 gives a control so as not to change the virtual input device.

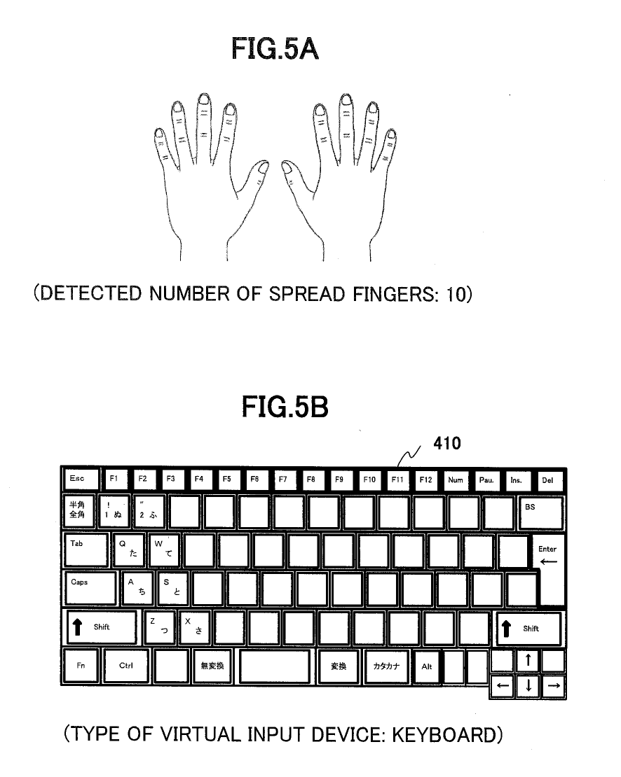

A specific explanation will be given of a relationship between the number of user's spread fingers detected by the shape detector 311 and the virtual input device to be displayed with reference to FIGS. 5A-7B.

First of all, an explanation will be given of a case in which the number of user's spread fingers detected by the shape detector 311 is 10 with reference to FIG. 5A. The output controller 330 selects a “keyboard” that has an item number 1 as the virtual input device to be projected based on the table illustrated in FIG. 3 since the number of user's spread fingers detected is equal to or greater than six. Next, the output controller 330 obtains the image information on the selected “keyboard” from the memory 130, and provides the image information to the projection device 120. Subsequently, as illustrated in FIG. 5B, the projection device 120 projects an image 410 of the virtual keyboard. When, for example, the user inputs “i-n-v-e-n-t-i-o-n” via the projected virtual keyboard, the input information specifier 312 analyzes the picked-up image by the pickup device 110, and specifies that the input information by the user is “i-n-v-e-n-t-i-o-n”. Next, the communicator 140 transmits the specified information “i-n-v-e-n-t-i-o-n” to the personal computer 200. The personal computer 200 displays the obtained information “i-n-v-e-n-t-i-o-n” on the display 210.

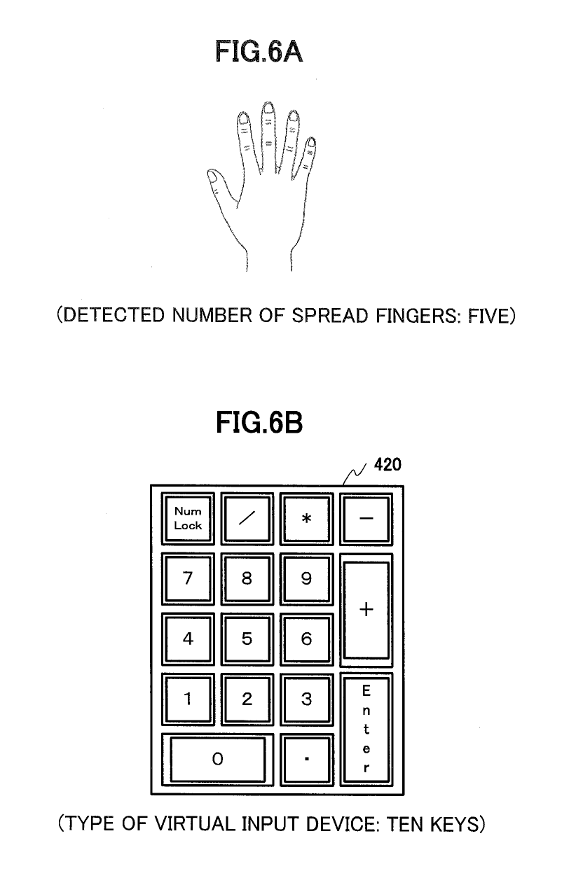

Next, an explanation will be given of a case in which the number of user's spread fingers detected by the shape detector 311 is five with reference to FIG. 6A. The output controller 330 selects “ten keys” that have an item number 2 as the virtual input device to be projected based on the table illustrated in FIG. 3 since the number of user's spread fingers detected is five. Next, the output controller 330 obtains the projection image information on the selected “ten keys” from the memory 130, and provides the projection image information to the projection device 120. Subsequently, as illustrated in FIG. 6B, the projection device 120 projects an image 420 of the virtual ten keys. When, for example, the user inputs “2+3=” via the projected virtual ten keys, the input information specifier 312 analyzes the picked-up image by the pickup device 110, and specifies that the input information by the user is “2+3=”. Next, the communicator 140 transmits the specified information to the personal computer 200. The personal computer 200 displays the obtained information “2+3=” on the display 210.

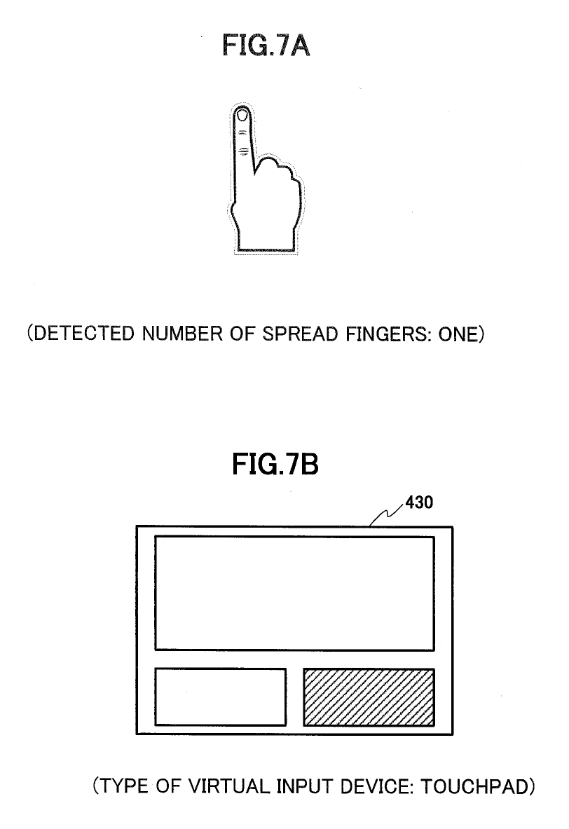

Next, an explanation will be given of a case in which the number of user's spread fingers detected by the shape detector 311 is one with reference to FIG. 7A. The output controller 330 selects a “touchpad” that has an item number 3 as the virtual input device to be projected based on the table illustrated in FIG. 3 since the number of user's spread fingers detected is one. Next, the output controller 330 obtains the projection image information on the selected “touchpad” from the memory 130, and provides the projection image information to the projection device 120. Subsequently, as illustrated in FIG. 7B, the projection device 120 projects an image 430 of the virtual touch pad. For example, the user is capable of selecting a function display by a finger action that depresses the lower right area of the touchpad illustrated in FIG. 7B. The input information specifier 312 specifies, from the picked-up image by the pickup device 110, the input information by the user is “function display”. Next, the communicator 140 transmits the specified information to the personal computer 200. The personal computer 200 displays the “function display” on the display 210.

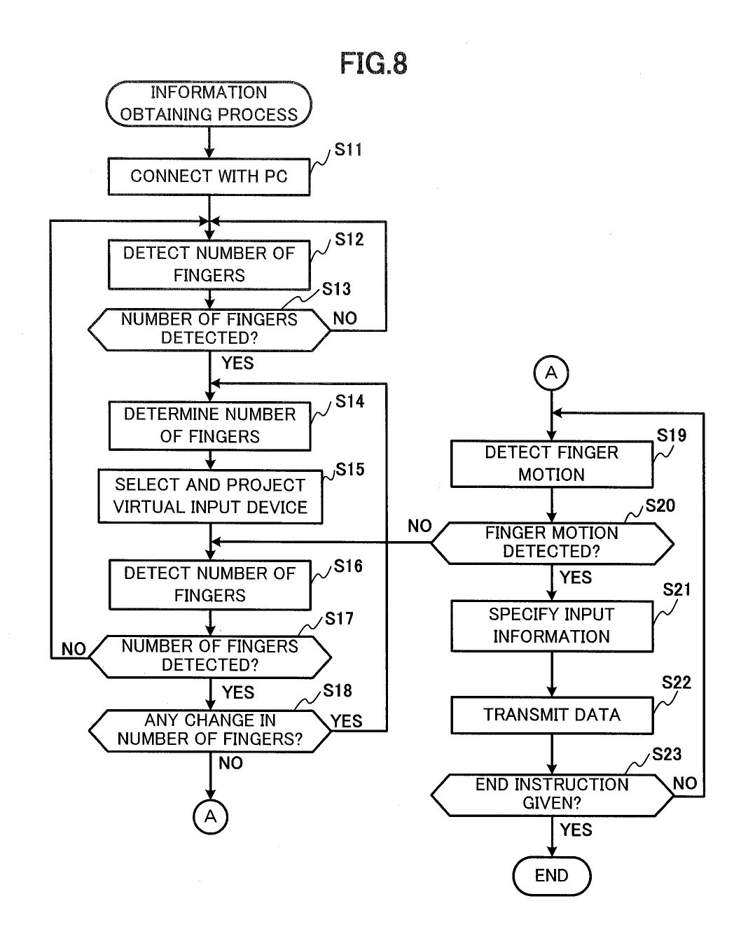

Subsequently, an explanation will be given of an information obtaining process executed by the information processing device 100 employing the above structure with reference to the flowchart in FIG. 8. The table illustrated in FIG. 3 is stored in the memory 130 beforehand in this case. When the user starts executing the application program for the virtual input device, the flowchart in FIG. 8 starts.

Upon execution of the application program for the virtual input device, the information processing device 100 connects (step S11) a communication line between the information processing device 100 and the personal computer 200. When the communication line connection with the personal computer 200 completes, the shape detector 311 analyzes the picked-up image by the pickup device 110, and detects (step S12) the number of user's spread fingers. When the user's finger is not detectable from the picked-up image (step S13: NO), the shape detector 311 keeps attempting to detect the number of user's spread fingers.

Conversely, when the user's finger is detected from the picked-up image (step S13: YES), the shape detector 311 determines (step S14) how many the number of user's spread fingers is detected. When the number of user's spread fingers is eventually determined, the output controller 330 selects the virtual input device to be projected based on the table illustrated in FIG. 3 and stored in the table memory 320. Next, the output controller 330 obtains the projection image information on this virtual input device from the memory 130, and provides the obtained information to the projection device 120. Subsequently, the projection device 120 projects (step S15) the supplied projection image of the virtual input device.

During the process of projecting the virtual input device, the shape detector 311 keeps attempting to detect (step S16) the number of user's spread fingers. Next, when the number of user's spread fingers becomes undetectable (step S17: NO), the shape detector 311 returns the process to the step S12, and starts over the process. When the number of user's spread fingers is detected (step S17: YES), and when the detected number of user's spread fingers changes (step S18: YES), the shape detector 311 returns the process to the step S14, determines again the number of fingers, and starts over selecting the virtual input device to be projected.

Conversely, when there is no change in the number of spread fingers detected from the image (step S18: NO), the process progresses to a specifying process of the input information by the user. The image analyzer 310 keeps attempting to detect (step S19) the motion of the user's finger during the specifying process of the input information. When there is no finger motion for a predetermined time period (step S20: NO), the process progresses to the step S16, and the number of user's spread fingers is detected again. This is because there is a possibility that the displayed virtual input device differs from the desired input device by the user. The time period for determining the presence and absence of the finger motion is set as a predetermined time period (for example, five seconds) in this case. When the input information specifier 312 has not processed the input information by the user for the predetermined time period, the input status determiner 313 determines that the user input is suspended. By monitoring the input status in this way, the output controller 330 processes so as not to change the virtual input device while the user is inputting the information.

When the user continuously motions the finger to input the information (step S20: YES), the input information specifier 312 specifies (step S21) the input information by the user based on the user's finger motion. In this embodiment, the input information specifier 312 specifies the key designated by the user over the input screen of the virtual input device based on the position of the user's finger and the motion thereof. In addition, when the selected virtual input device is a touchpad, the input information is specified based on the user's finger motion.

Next, the communicator 140 transmits (step S22) the specified input information to the personal computer 200. When there is no end instruction given by the user (step S23: NO), the information processing device 100 repeatedly executes the processes from the step S19 to the step S23. Conversely, when there is an end instruction given by the user (step S23: YES), the information processing device 100 ends the process.

### First Modified Example

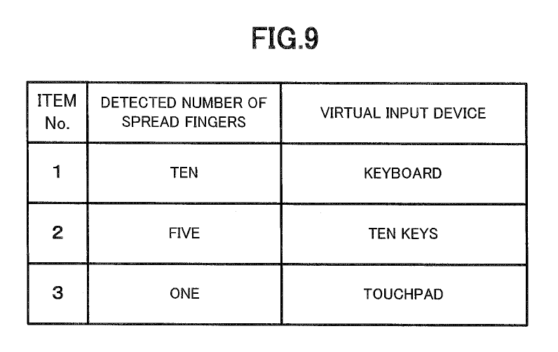

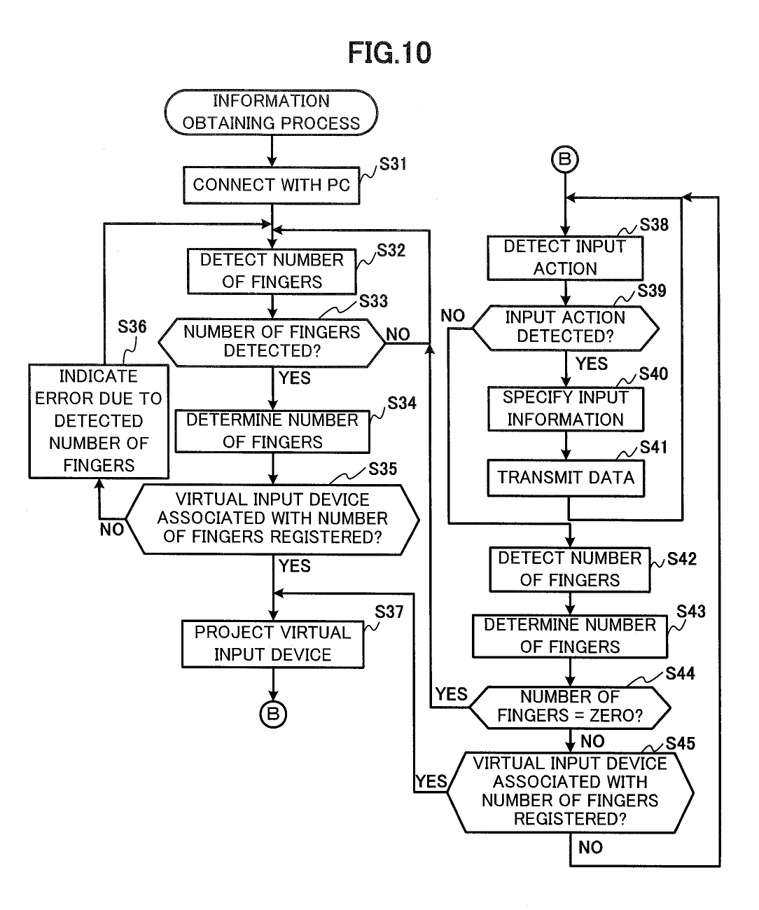

The method for the information obtaining process by the information processing device 100 is not limited to the method explained in the first embodiment with reference to the flowchart in FIG. 8, and various modifications are applicable. An explanation will be given of a case in which, for example, the table illustrated in FIG. 3 is modified to a table illustrated in FIG. 9 with reference to the flowchart in FIG. 10. That is, this is a case in which there is no associated virtual input device set for the detected number of fingers, such as nine or three. The table illustrated in FIG. 9 is stored in the memory 130 beforehand in this case. When the user starts executing the application program for the virtual input device, the flowchart in FIG. 10 starts.

Upon execution of the application program for the virtual input device, the information processing device 100 connects (step S31) a communication line between the information processing device 100 and the personal computer 200. When the communication line connection with the personal computer 200 completes, the shape detector 311 analyzes the picked-up image by the pickup device 110, and detects (step S32) the number of user's spread fingers. When the user's finger is not detectable from the picked-up image (step S33: NO), the shape detector 311 returns the process to the step S32, and keeps attempting to detect the number of user's spread fingers.

Conversely, when the user's finger is detected from the picked-up image (step S33: YES), the shape detector 311 determines (step S34) the detected number of user's spread fingers. When the number of user's spread fingers is eventually determined, the output controller 330 refers to the table illustrated in FIG. 9 and stored in the table memory 320, and determines (step S35) whether or not the virtual input device associated with the detected number of spread fingers is registered in the table. When, for example, the detected number of spread fingers is eight, no virtual input device associated with the eight spread fingers is registered in the table in FIG. 9. When there is no registered virtual input device associated with the detected number of spread fingers in the table (step S35: NO), an error indication is made (step S36), and the process returns to the process in the step S32.

Conversely, when the virtual input device associated with the detected number of spread fingers is registered in the table (step S35: YES), the output controller 330 selects the virtual input device to be projected. Next, the projection image information on this virtual input device is obtained from the memory 130, and is provided to the projection device 120. Subsequently, the projection device 120 projects (step S37) the projection image of this virtual input device.

The image analyzer 310 keeps attempting to detect (step S38) the user's finger motion while the input screen (image) of the virtual input device is being projected. When there is no finger motion for the predetermined time period (step S39: NO), the process progresses to the step S42, and the number of spread fingers is detected again (step S43). This is because there is a possibility that the projected virtual input device differs from the desired input device by the user. When the input information specifier 312 has not processed the input information by the user for the predetermined time period, the input status determiner 313 determines that the user input is suspended. By observing the input status in this way, the output controller 330 processes so as not to change the virtual input device while the user is inputting the information.

Upon re-detection of the number of spread fingers, when the number of spread fingers is zero (step S44: YES), the process returns to the step S32, and the detecting process of the number of spread fingers is started over. Conversely, when the detected number of spread fingers is not zero (step S44: NO) and the virtual input device associated with the detected number of spread fingers is registered in the table illustrated in FIG. 9 (step S45: YES), the process returns to the step S37, and the new virtual input device is selected and projected. This is a case in which, for example, the user initially shows the 10 fingers and desires to input characters but then desires to execute a numerical calculation, and hides the one hand. In this case, sine the detected number of spread fingers is initially 10, the keyboard that has the item number 1 is projected. Subsequently, when the user hides the one hand, the detected number of spread fingers becomes five, and the ten keys that has the item number 2 in the table illustrated in FIG. 9 is associated with this detected number. Hence, the projected virtual input device is changed to the ten keys.

Conversely, although there is a change in detected number of spread fingers, when the virtual input device associated with the detected number of spread fingers is not registered in the table illustrated in FIG. 9 (step S45: NO), the process returns to the step S38, and the input-operation detecting process is continued. This is a case in which, for example, the fifth finger is out of the imaging area of the pickup device 110. In this case, since an estimation that the user desires a change in virtual input device is not surely probable, the information processing device 100 maintains the projected virtual input device, and keeps obtaining the input information by the user.

Conversely, when the user motions the finger and keeps inputting the information (step S39: YES), the input information specifier 312 specifies (step S40) the input information by the user based on the motion of the user's finger. Next, the transmitter 140 transmits (step S41) the specified input information to the personal computer 200. When the user does not give an end instruction, the information processing device 100 repeatedly executes the processes from the step S38 to the step S40. Conversely, when the user gives the end instruction, the information processing device 100 ends the process.

### Second Modified Example

In the first embodiment, the explanation has been given of an example case in which the image of the user's finger motioning on the input screen of the displayed virtual input device is picked up, and the input information by the user is specified based on the picked-up user's finger motion. However, how to specify the input information by the user is not limited to this method. For example, the projection device 120 may display the input screen of the virtual input device, and also emit light so as to overlap the input screen. Next, the pickup device 110 may pick up light reflected by the user's finger motioning on the input screen of the displayed virtual input device. Subsequently, the input information specifier 312 may specify the position indicated by the user's finger based on the picked-up light, analyze the information on the input key based on the specified position, and specify the input information by the user.

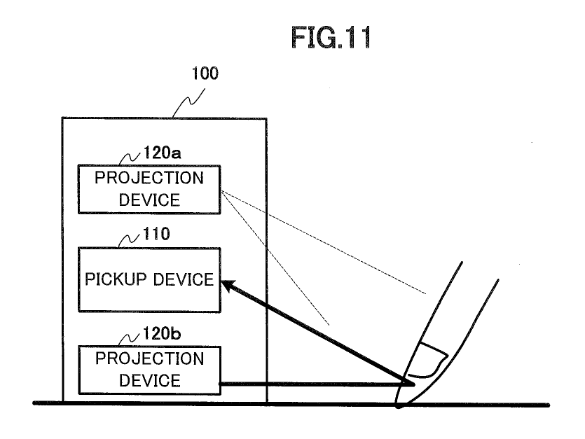

For example, as illustrated in FIG. 11, an projection device 120a displays the projection image of the virtual input device that is the “keyboard” which has the item number 1 in FIG. 3 by red semiconductor laser. In addition, an projection device 120b projects infrared laser (light) so as to overlap the projection image of the “keyboard” displayed by the projection device 120a. When there is no user's finger present, since there is no obstacle, the infrared laser travels linearly, and thus the pickup device 110 does not pick up the infrared laser. Conversely, when, for example, the user depresses the key “k” of the virtual keyboard, the infrared laser projected at the position of the key “k” is reflected by the user's finger. This causes the pickup device 110 to pick up the reflected infrared laser, and thus information on the position of the user's finger is obtained based on this reflected user's finger. The input information specifier 312 analyzes this information, thereby becoming possible to specify the input information by the user.

As for the light, light available from an optical communication module for optical communications is also applicable other than the infrared laser. In addition, high-frequency radio waves that have a high linear traveling characteristic are also applicable.

As explained above, according to the information processing device 100 in this embodiment, the number of user's spread fingers is detected, the virtual input device associated with the specified number of fingers is selected, and the projection image of the selected virtual input device is displayed. This enables the information processing device 100 to automatically select and provide the virtual input device matching the utilization purpose of the user among the multiple types of virtual input devices.

In addition, the information processing device 100 according to this embodiment includes the shape detector 311, and displays the virtual input device associated with the number of spread fingers presented by the user. This eliminates the necessity for the information processing device 100 to have a physical keyboard and the like to select the virtual input device. In addition, the selection operation of the virtual input device by the user can be simplified.

Still further, the information processing device 100 according to this embodiment includes the table memory 320 that associates the number of spread fingers presented by the user with the virtual input device to be selected. Hence, by simply changing the definition of the table in this memory, a flexible setting can be made for a change in virtual input device to be selected and a change in selection method.

Yet still further, the information processing device 100 according to this embodiment includes the input information specifier 312, and specifies the input information that the user attempts to input based on the motion of the user's finger on the input screen of the virtual input device. This enables the information processing device 100 to accomplish the function as the virtual input device.

In addition, by detecting the information on the multiple input keys in the virtual input device using light like the infrared laser that has the high linear traveling characteristic, the precision of the specified information input by the user is enhanced.

Still further, the information processing device 100 according to this embodiment includes the input status determiner 313, and determines whether or not the user is inputting the information. This prevents the information processing device 100 from changing the virtual input device while the user is inputting the information.

Yet still further, the information processing device 100 according to this embodiment includes the communicator 140. This enables the information processing device 100 to transmit the input information by the user to the other devices, and to function as the external input device for the other device.

In the above embodiment, the explanation has been given of an example case in which the information processing device 100 and the personal computer 200 are separately implemented. However, the information processing device 100 and the personal computer 200 may be implemented by a single apparatus.

In addition, in the above embodiment, the explanation has been given of an example case in which the shape detector 311 detects the number of user's spread fingers. However, how to specify the virtual input device is not limited to this case. For example, the virtual input device may be selected based on the shape of hand, such as rock, scissors, or paper. In addition, the virtual input device may be selected upon an association of the virtual input device with the shapes of hand, such as a circle, a cross, a triangle, and a rectangle.

Still further, in the above embodiment, the explanation has been given of an example case in which the virtual input device is the keyboard, the ten keys, or the touchpad. However, the virtual input device is not limited to such types of input devices. For example, the virtual input device may be a joystick, a mouse, and the like. When a virtual input device for gaming is expected, the handle of a vehicle, a piano, a guitar, a drum, and the like may be adopted as the virtual input device.

Yet still further, in the above embodiment, the explanation has been given of an example case in which the projection device 120 displays the projection image of the selected virtual input device on a desk or the like with reference to FIGS. 2 and 11. However, how to display the virtual input device by the projection device 120 is not limited to this case. For example, the projection device 120 may turn on corresponding Light Emitting Diodes (LEDs) of a display panel including multiple LEDs to display the image of the selected virtual input device on the display panel. In addition, a touch panel is applicable as the display panel.

In addition, in the above embodiment, the explanation has been given of an example case in which the input status determiner 313 determines the input status by the user based on the processing status of the input information specifier 312. However, how to determine the input status is not limited to this case. For example, the input status determiner 313 may determine the input status based on the motion of the user's finger picked up by the pickup device 110.

As for the timing at which the virtual input device is changed, for example, the input status may be determined based on a change in number of user's spread fingers picked up by the pickup device 110. More specifically, upon a situation in which the user's hand is not detectable from the picked-up image, the virtual input device may be changed. In addition, the specific shape of the hand or motion thereof may be defined beforehand, and upon detection of such a shape of the hand or motion, the virtual input device may be changed.

Although the information processing device 100 that has the structure beforehand to accomplish the functions according to the present disclosure is providable, conventional personal computers, information terminal devices, and the like may be caused to function as the information processing device 100 according to the present disclosure by applying a program. That is, by applying a program to accomplish the respective functions of the information processing device 100 exemplified in the above embodiment so as to be executable by a CPU and the like that controls conventional personal computers and information terminal devices, the information processing device 100 according to the present disclosure is accomplishable. An information processing method according to the present disclosure can be carried out using the information processing device 100.

How to apply such a program is optional. For example, the program stored in a non-transitory computer readable recording medium, such as a Compact Disc Read-Only Memory (CD-ROM), a Digital Versatile Disc (DVD), or a Magneto Optical disc (MO) is applicable. In addition, the program may be stored in the storage device over a network like the Internet, and may be downloaded for an application.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An information processing device comprising:
a shape detector that detects a shape of a detection object;
an output controller that performs a control to select a virtual input device to be displayed based on the detected shape of the detection object, and to display the selected virtual input device; and
a display that displays the selected virtual input device based on the given control by the output controller.

2. The information processing device according to claim 1, wherein the detection object detected by the shape detector is a hand of a user.

3. The information processing device according to claim 1, wherein:
the shape detector detects a number of user's spread fingers; and
the output controller selects the virtual input device to be displayed based on the detected number of fingers.

4. The information processing device according to claim 2, wherein:
the shape detector detects a number of user's spread fingers; and
the output controller selects the virtual input device to be displayed based on the detected number of fingers.

5. The information processing device according to claim 1, further comprising an pickup device that picks up an image of a specific area,
wherein the shape detector specifies the shape of the detection object based on the image picked up by the pickup device.

6. The information processing device according to claim 2, further comprising an pickup device that picks up an image of a specific area,
wherein the shape detector specifies the shape of the detection object based on the image picked up by the pickup device.

7. The information processing device according to claim 3, further comprising an pickup device that picks up an image of a specific area,
wherein the shape detector specifies the shape of the detection object based on the image picked up by the pickup device.

8. The information processing device according to claim 4, further comprising an pickup device that picks up an image of a specific area,
wherein the shape detector specifies the shape of the detection object based on the image picked up by the pickup device.

9. The information processing device according to claim 1, further comprising a memory storing a table that associates the shape of the detection object with the virtual input device to be displayed,
wherein the output controller selects the virtual input device to be displayed based on the shape of the detection object detected by the shape detector, and the table.

10. The information processing device according to claim 2, further comprising a memory storing a table that associates the shape of the detection object with the virtual input device to be displayed,
wherein the output controller selects the virtual input device to be displayed based on the shape of the detection object detected by the shape detector, and the table.

11. The information processing device according to claim 3, further comprising a memory storing a table that associates the shape of the detection object with the virtual input device to be displayed,
wherein the output controller selects the virtual input device to be displayed based on the shape of the detection object detected by the shape detector, and the table.

12. The information processing device according to claim 4, further comprising a memory storing a table that associates the shape of the detection object with the virtual input device to be displayed,
wherein the output controller selects the virtual input device to be displayed based on the shape of the detection object detected by the shape detector, and the table.

13. The information processing device according to claim 5, further comprising a memory storing a table that associates the shape of the detection object with the virtual input device to be displayed,
wherein the output controller selects the virtual input device to be displayed based on the shape of the detection object detected by the shape detector, and the table.

14. The information processing device according to claim 5, further comprising a specifier that specifies information input by the detection object based on a motion of the detection object picked up by the pickup device.

15. The information processing device according to claim 5, wherein:
the display displays an input screen of the virtual input device, and also outputs light so as to overlap the input screen;
the pickup device picks up the light reflected by the detection object motioning on the displayed input screen of the virtual input device; and
the information processing device further comprises a specifier specifying information input by the detection object based on the light picked up by the pickup device and information on the input screen.

16. The information processing device according to claim 15, wherein the light is emitted by an infrared laser.

17. The information processing device according to claim 14, further comprising an input status determiner that determines whether or not the detection object is inputting information based on a processing status of the input information by the specifier,
wherein the output controller maintains the displayed virtual input device when the input status determiner determines that the detection object is inputting the information.

18. The information processing device according to claim 14, further comprising a transmitter that transmits the specified input information by the specifier to another information processing device.

19. An information processing method by an information processing device, the method comprising:
detecting a shape of a detection object;
performing a control to select a virtual input device to be displayed based on the detected shape of the detection object, and to display the selected virtual input device; and
displaying the selected virtual input device based on the given control.

20. A non-transitory computer readable memory medium having stored therein a program containing sequential instructions to be executed by a computer comprising a display that displays a virtual input device, the program causing the computer to function as:
a shape detector that detects a shape of a detection object;
an output controller that performs a control to select a virtual input device to be displayed based on the detected shape of the detection object, and to display the selected virtual input device; and
a display that displays the selected virtual input device based on the control given by the output controller.
